(19) United States
(12) Patent Application Publication
(10) Pub. No.: US 2013/0134813 A1
(43) Pub. Date: May 30, 2013

(54) SPINDLE MOTOR

(71) Applicants: Kwan Soo YUN, Suwon (KR); Song Bon OH, Suwon (KR)

(72) Inventors: Kwan Soo YUN, Suwon (KR); Song Bon OH, Suwon (KR)

(73) Assignee: SAMSUNG ELECTRO-MECHANICS CO., LTD, Suwon (KR)

(21) Appl. No.: 13/609,559

(22) Filed: Sep. 11, 2012

(30) Foreign Application Priority Data
Nov. 28, 2011 (KR) 10-2011-0124988

(51) Int. Cl. H02K 7/08

(52) U.S. Cl. 310/90

(57) ABSTRACT

There is provided a spindle motor including: a sleeve rotatably supporting a shaft; a thrust plate fixedly installed on the shaft to be disposed above the sleeve; a cap member fixedly installed on the sleeve and forming a liquid-vapor interface between a lubricating fluid and surrounding air together with the thrust plate; and a buffering member installed on a lower surface of the cap member.

### CROSS-REFERENCE TO RELATED APPLICATIONS

This application claims the priority of Korean Patent Application No. 10-2011-0124988 filed on Nov. 28, 2011, in the Korean Intellectual Property Office, the disclosure of which is incorporated herein by reference.

### BACKGROUND OF THE INVENTION

1. Field of the Invention

The present invention relates to a spindle motor.

2. Description of the Related Art

A small-sized spindle motor used for a hard disk drive (HDD) generally includes a hydrodynamic bearing assembly, a bearing clearance provided therein being filled with a lubricating fluid.

In addition, during the rotation of a shaft, the lubricating fluid filling the bearing clearance is pumped to form fluid dynamic pressure therein, thereby rotatably supporting the shaft.

Meanwhile, the hydrodynamic bearing assembly may include a cap member allowing an interface between the lubricating fluid and surrounding air to be formed in order to suppress leakage of the lubricating fluid filling the bearing clearance.

That is, the cap member serves to form the interface (that is, a liquid-vapor interface) between the lubricating fluid and the surrounding air, so that the lubricating fluid does not leak due to a capillary phenomenon during normal driving of the spindle motor.

The cap member as described above is generally disposed above a thrust plate and forms the liquid-vapor interface together therewith. To this end, the cap member may be fixedly installed on a sleeve.

However, in the case in which an external impact is transferred to the spindle motor, the thrust plate may be moved due to the transferred external impact and contact the cap member, such that the impact is applied to the cap member.

As a result, the cap member may be damaged.

In addition, even in the case that the cap member is not damaged, the cap member may be vibrated due to the transferred impact, such that a natural frequency thereof may be generated due to the vibrations.

In this case, if the natural frequency coincides with a natural frequency generated in another component (for example, a stator core) included in the spindle motor, a resonance phenomenon may be generated.

Further, due to the generation of the resonance phenomenon, in the case of writing data to a recording disk or reading data written on a recoding disk, an error may be generated.

### SUMMARY OF THE INVENTION

An aspect of the present invention provides a spindle motor in which a cap member thereof may not be damaged in the case that an external impact is transferred thereto.

Another aspect of the present invention provides a spindle motor in which a resonance phenomenon is reduced.

According to an aspect of the present invention, there is provided a spindle motor including: a sleeve rotatably supporting a shaft; a thrust plate fixedly installed on the shaft to be disposed above the sleeve; a cap member fixedly installed on the sleeve and forming a liquid-vapor interface between a lubricating fluid and surrounding air together with the thrust plate; and a buffering member installed on a lower surface of the cap member.

The buffering member may be inserted into an installation groove formed at an inner diameter portion of the lower surface of the cap member and protrudes downwardly from the lower surface of the cap member.

The buffering member may be formed of an O ring made of a material having elasticity.

The buffering member may be formed of tape adhered to a region at which the lower surface of the cap member and the thrust plate contact each other at the time of an external impact.

The cap member may have an inclined surface formed on the lower surface thereof so as to form the liquid-vapor interface.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIG. 2 is an enlarged view of part A of FIG. 1;

FIG. 3 is a schematic cross-sectional view showing a spindle motor according to another embodiment of the present invention; and

FIG. 4 is an enlarged view showing part B of FIG. 3.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Further, detailed descriptions related to well-known functions or configurations will be ruled out in order not to unnecessarily obscure subject matters of the present invention.

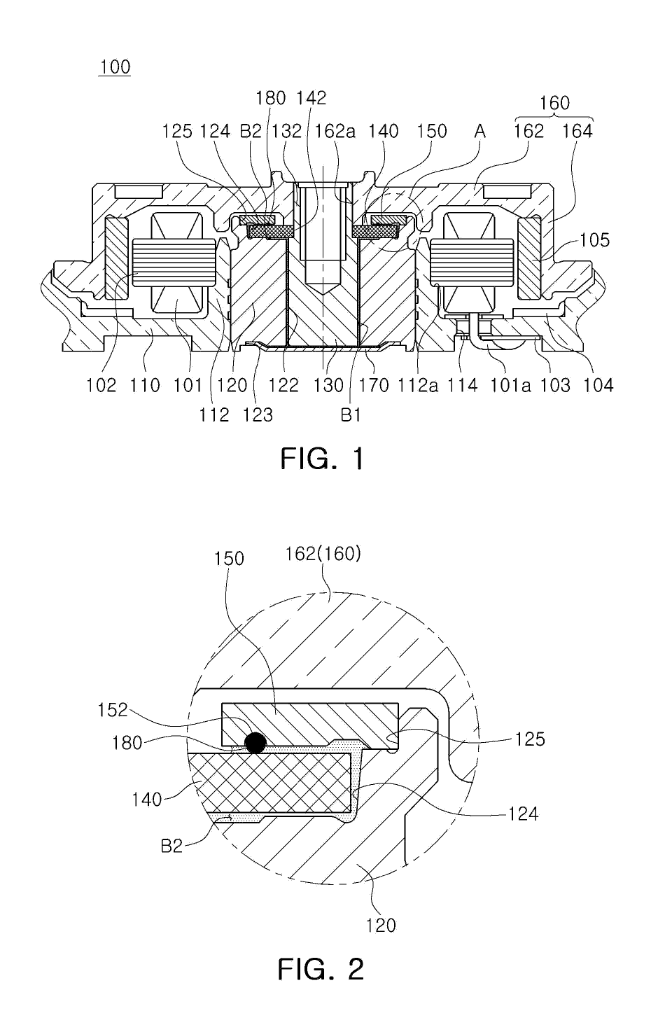

FIG. 1 is a cross-sectional view schematically showing a spindle motor according to an embodiment of the present invention; and FIG. 2 is an enlarged view showing part A of FIG. 1.

Referring to FIGS. 1 and 2, a spindle motor 100 according to the embodiment of the present invention may include a base member 110, a sleeve 120, a shaft 130, a thrust plate 140, a cap member 150, a rotor hub 160, a cover member 170, and a buffering member 180, by way of example.

Here, terms with respect to directions will be first defined. As viewed in FIG. 1, an axial direction refers to a vertical direction, that is, a direction from an upper portion of the shaft 130 toward a lower portion thereof or a direction from the lower portion of the shaft 130 toward the upper portion thereof, and a radial direction refers to a horizontal direction, that is, a direction from an outer peripheral surface of the rotor hub 160 toward the shaft 130 or from the shaft 130 toward the outer peripheral surface of the rotor hub 160.

In addition, a circumferential direction refers to a rotation direction along the outer peripheral direction of the rotor hub 160.

The base member 110 may include a protrusion part 112 having the sleeve 120 installed therein. The protrusion part 112 may protrude in an upward axial direction and have a hollow cylindrical shape. In addition, the sleeve 120 may be insertedly installed in the protrusion part 112.

Further, the protrusion part 112 may include a stator core 102 installed on an outer peripheral surface thereof, wherein the stator core 102 has a coil 101 wound therearound. That is, the stator core 102 may be fixedly installed on the protrusion part 112 by an adhesive and/or welding in a state in which it is seated on a seat surface 112a formed on the outer peripheral surface of the protrusion part 112.

In addition, the base member 110 may include a lead hole 114 formed so as to be disposed in the vicinity of the protrusion part 112. In addition, a lead part 101a of the coil 101 wound around the stator core 102 may be led from an upper portion of the base member 110 toward a lower portion thereof through the lead hole 114.

Meanwhile, a circuit board 103 may be installed on a lower surface of the base member 110 and the lead part 101a of the coil 101 may be bonded to the circuit board 103. In addition, the circuit board 103 may be a flexible circuit board.

In addition, the base member 110 may include a pulling plate 104 installed thereon in order to prevent the rotor hub 160 from being excessively floated, wherein the pulling plate 104 may have an annular ring shape.

The sleeve 120 may rotatably support the shaft 130. In addition, as described above, the sleeve 120 may be inserted into and fixedly installed on the protrusion part 112. That is, an outer peripheral surface of the sleeve 120 may be bonded to an inner peripheral surface of the protrusion part 112 by an adhesive.

However, the sleeve 120 is not limited to being bonded to the protrusion part 112 by the adhesive, but may also be press-fitted into the protrusion part 112 or be bonded to the protrusion part 112 by welding.

Further, the sleeve 120 may include a shaft hole 122 formed therein so that the shaft 130 may be insertedly disposed therein. That is, the sleeve 120 may have a hollow cylindrical shape.

Meanwhile, in the case in which the shaft 130 is insertedly disposed in the sleeve 120, an inner peripheral surface of the sleeve 120 and the outer peripheral surface of the shaft 130 may be spaced apart from each other by a predetermined interval to form a bearing clearance B1 therebetween. This bearing clearance B1 may be filled with a lubricating fluid.

In addition, the sleeve 120 may include a dynamic pressure groove (not shown) formed in the inner surface thereof so as to generate fluid dynamic pressure by pumping the lubricating fluid filling the bearing clearance B1 at the time of rotation of the shaft 130.

Further, the sleeve 120 may include the cover member 170 installed at a lower end portion thereof in order to prevent the lubricating fluid filling the bearing clearance B1 from being leaked downwardly. That is, the sleeve 120 may include a depression groove 123 depressed upwardly at the lower end portion thereof so that the cover member 170 may be installed therein.

In addition, the sleeve 120 may have an insertion groove 124 formed at an upper end portion thereof, wherein the insertion groove 124 has the thrust plate 140 insertedly disposed therein. The insertion groove 124 may have a shape corresponding to that of the thrust plate 140.

In addition, the sleeve 120 may include a cap member mounting part 125 formed at the upper end portion thereof, wherein the cap member mounting part 125 is disposed outwardly of the insertion groove 124 in a radial direction. The cap member mounting part 125 may be formed in the sleeve 120 so as to be disposed outwardly of the insertion groove 124 in the radial direction and may be disposed above the insertion groove 124. That is, the cap member mounting part 125 and the insertion groove 124 may form a step part.

The shaft 130 may be rotatably installed in the sleeve 120. That is, the shaft 130 may be insertedly disposed in the shaft hole 122 of the sleeve 120.

In addition, the shaft 130 may include an installation part 132 on which the thrust plate 140 and the rotor hub 160 are installed. That is, the shaft 130 may include the installation part 132 provided at the upper end portion thereof, wherein the installation part 132 has the thrust plate 140 and the rotor hub 160 installed thereon and allows the upper end portion of the shaft 130 to have a diameter smaller than that of a lower end portion thereof.

The thrust plate 140 may be fixedly installed on the shaft 130 to rotate together with the shaft 130. That is, the thrust plate 140 may be fixedly installed on the installation part 132 of the shaft 130. To this end, the thrust plate 140 may have a circular ring shape in which it includes an installation hole 142 formed therein so that the shaft 130 may penetrate therethrough.

Meanwhile, the thrust plate 140 may be insertedly disposed in the insertion groove 124 of the sleeve 120, and a bottom surface of the insertion groove 124 and a lower surface of the thrust plate 140 may be disposed to be spaced apart from each other by a predetermined interval to form a bearing clearance B2.

In addition, a thrust dynamic pressure groove (not shown) may be formed in at least one of the lower surface of the thrust plate 140 and the bottom surface of the insertion groove 124 in order to generate thrust fluid dynamic pressure at the time of the rotation of the shaft 130.

That is, in the case in which the thrust plate 140 rotates together with the shaft 130, force directed in an upward axial direction is generated by the thrust dynamic pressure groove, such that the rotor hub 160 may be floated at a predetermined height.

The cap member 150 may be fixedly installed on the sleeve 120 and form a liquid-vapor interface between the lubricating fluid and surrounding air together with the thrust plate 140. That is, the cap member 150 may be fixedly installed on the cap member mounting part 125 and serve to form the liquid-vapor interface together with the thrust plate 140.

In addition, the cap member 150 may include an installation groove 152 formed in an inner diameter portion of a lower surface thereof, and the installation groove 152 has the buffering member 180 inserted thereinto. The insertion groove 152 may have a shape corresponding to that of the buffering member 180.

The rotor hub 160 may be installed on the installation part 132 so as to be disposed above the thrust plate 140. Meanwhile, the rotor hub 160 may include a body 162 including a mounting hole 162a having the installation part 132 of the shaft 130 inserted thereinto and a magnet mounting part 164 extended from an edge of the body 162 downwardly in an axial direction.

The magnet mounting part 164 may have a magnet 105 installed on an inner surface thereof, and the magnet 105 is disposed to face a front end of the stator core 102 having the coil 101 wound around.

Meanwhile, the magnet 105 may have an annular ring shape and be a permanent magnet generating magnetic force having a predetermined strength by alternately magnetizing an N pole and an S pole in the circumferential direction.

Here, rotational driving of the rotor hub 160 will be described. When power is supplied to the coil 101 wound around the stator core 102, driving force capable of rotating the rotor hub 160 may be generated by electromagnetic interaction between the magnet 105 and the stator core 102 having the coil 101 wound therearound.

Therefore, the rotor hub 160 rotates, such that the shaft 140 to which the rotor hub 160 is fixedly coupled may rotate together with the rotor hub 160.

The cover member 170 may be installed in the depression groove 123 formed at the lower end portion of the sleeve 120 to thereby prevent the lubricating fluid from being leaked downwardly. Further, the cover member 170 may be fixedly installed in the depression groove 124 by an adhesive and/or welding. In the case in which the cover member 170 is installed in the sleeve 120, the lubricating fluid may also fill a space between the cover member 170 and the sleeve 120.

The buffering member 180 may be installed on the lower surface of the cap member 150. That is, the buffering member 180 may be insertedly mounted in the installation groove 152 formed in the cap member 150 and be disposed to protrude downwardly from the lower surface of the cap member 150 at the time of being mounted in the installation groove 152.

In addition, the buffering member 180 may be formed of an O ring made of a material having elasticity.

As described above, the buffering member 180 is disposed to protrude downwardly from the lower surface of the cap member 150, and accordingly, in the case in which the thrust plate 140 is moved due to an external impact, the buffering member 180 contacts the thrust plate 140, whereby damage to the cap member 150 may be reduced.

In addition, since the buffering member 180 contacts the thrust plate 140, vibration of the cap member 150 may be suppressed when the external impact is applied thereto. Therefore, the generation of a natural frequency due to the vibration of the cap member 150 may be reduced.

As a result, the generation of a resonance phenomenon due to the generation of the natural frequency may be suppressed.

Hereinafter, a spindle motor according to another embodiment of the present invention will be described with reference to the accompanying drawings. However, a detailed description of the same components as the above-mentioned components will be omitted.

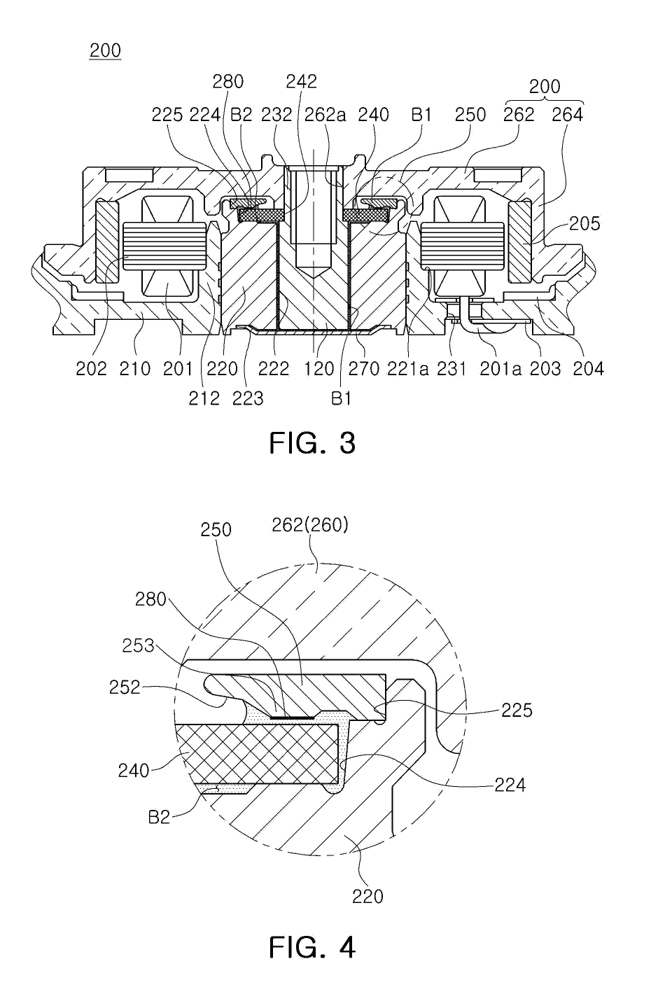

FIG. 3 is a cross-sectional view schematically showing a spindle motor according to another embodiment of the present invention; and FIG. 4 is an enlarged view showing part B of FIG. 3.

Referring to FIGS. 3 and 4, a spindle motor 200 according to another embodiment of the present invention may include a base member 210, a sleeve 220, a shaft 230, a thrust plate 240, a cap member 250, a rotor hub 260, a cover member 270, and a buffering member 280, by way of example.

Meanwhile, the base member 210, the sleeve 220, the shaft 230, the thrust plate 240, the rotor hub 260, and the cover member 270 included in the spindle motor 200 according to this embodiment of the present invention are substantially the same as the base member 110, the sleeve 120, the shaft 130, the thrust plate 140, the rotor hub 160, and the cover member 170 included in the spindle motor 100 according to the above-described embodiment of the present invention. Therefore, a detailed description thereof will be omitted.

The cap member 250 may be fixedly installed on the sleeve 220. That is, the cam member 250 may be fixedly installed on a cap member mounting part 225 and serve to form a liquid-vapor interface together with the thrust plate 240. To this end, an inclined surface 252 may be formed on a lower surface of the cap member 250 so as to form the liquid-vapor interface (that is, an interface between a lubricating fluid and surrounding air) together with the thrust plate 240.

In addition, the cap member 250 may include a protrusion part 253 formed on the lower surface thereof, wherein the protrusion part 253 is connected to the inclined surface 252 and protrudes toward an upper surface of the thrust plate 240.

Meanwhile, the buffering member 280 may be installed on the lower surface of the cap member 250. That is, the buffering member 280 may be installed at a region at which the lower surface of the cap member 250 and the thrust plate 240 contact each other at the time of an external impact.

More specifically, the buffering member 280 may be bonded to the protrusion part 253 of the cap member 250 and be disposed to protrude downwardly from the lower surface of the cap member 250.

In addition, the buffering member 280 may be formed of tape having elasticity to thereby be adhered to the protrusion part 253 of the cap member 250.

As described above, the buffering member 280 is installed to protrude downwardly from the lower surface of the cap member 250, and accordingly, in the case in which the thrust plate 240 is moved due to the external impact, the buffering member 280 contacts the thrust plate 240, whereby damage to the cap member 250 may be reduced.

In addition, since the buffering member 280 contacts the thrust plate 240, vibration of the cap member 250 may be suppressed at the time of the external impact. Therefore, the generation of a natural frequency due to the vibration of the cap member 250 may be reduced.

As a result, the generation of a resonance phenomenon due to the generation of the natural frequency may be suppressed.

As set forth above, according to the embodiments of the present invention, the buffering member is used, whereby the damage to the cap member at the time of an external impact may be reduced and the generation of a resonance phenomenon may be reduced.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a sleeve rotatably supporting a shaft;
a thrust plate fixedly installed on the shaft to be disposed above the sleeve;
a cap member fixedly installed on the sleeve and forming a liquid-vapor interface between a lubricating fluid and surrounding air together with the thrust plate; and
a buffering member installed on a lower surface of the cap member.

2. The spindle motor of claim 1, wherein the buffering member is inserted into an installation groove formed at an inner diameter portion of the lower surface of the cap member and protrudes downwardly from the lower surface of the cap member.

3. The spindle motor of claim 2, wherein the buffering member is formed of an O ring made of a material having elasticity.

4. The spindle motor of claim 1, wherein the buffering member is formed of tape adhered to a region at which the lower surface of the cap member and the thrust plate contact each other at the time of an external impact.

5. The spindle motor of claim 4, wherein the cap member has an inclined surface formed on the lower surface thereof so as to form the liquid-vapor interface.
